(19) United States
(12) Patent Application Publication
(10) Pub. No.: US 2026/0007255 A1
(43) Pub. Date: Jan. 8, 2026

(54) A REFRIGERATION UNIT AND SYSTEM

(71) Applicants: Gabriel Ovadia, Hagor (IL); Alicia Aliki Sarrano, Hagor (IL)

(72) Inventors: Gabriel Ovadia, Hagor (IL); Alicia Aliki Sarrano, Hagor (IL)

(21) Appl. No.: 19/110,890

(22) PCT Filed: Sep. 12, 2023
(86) PCT No.: PCT/IL2023/050988

§ 371 Date: Mar. 12, 2025

Related U.S. Application Data
(60) Provisional application No. 63/405,889, filed on Sep. 13, 2022.

(51) Int. Cl. A47F 3/04; A47F 3/06

(52) U.S. Cl. CPC A47F 3/0434; A47F 3/063

(57) ABSTRACT

Disclosed is a refrigeration unit having a drawers housing structure to accommodate two or more drawers positioned, within the housing structure, at a substantially similar height to each other and over the same plane. The drawers housing structure includes a transparent, substantially flat, top surface to collectively cover the top openings of the two or more drawers when positioned within the housing structure, while enabling a top view through the transparent surface, of items stored in the drawers.

### FIELD OF THE INVENTION

The present invention generally relates to the field of storage, refrigeration, and stock management. More specifically, the present invention relates to a refrigeration unit and system.

### BACKGROUND

There remains a need, in the field of storage and refrigeration of items and foods such as fruits and vegetables, for solutions facilitating enhanced stock management of, and interface with, refrigerated stored items. Such solutions and designs can gain enhanced user experience and stock control, enable user on-the-fly inspection of stock quantities and quality, and a provide higher and easier access to contents stored in the refrigeration units.

### SUMMARY OF THE INVENTION

A storage or refrigeration unit, in accordance with embodiments of the present invention, may include a drawers housing structure/frame to accommodate one or more drawers positioned, within the housing structure, at a substantially similar height to each other and over the same plane. The drawers housing structure/frame may include a transparent, substantially flat, top surface/sheet/layer to collectively cover the top openings of the two or more drawers when positioned within the housing structure/frame, while enabling a top view through the transparent surface, of items stored in the drawers.

The transparent, substantially flat, top surface/sheet/layer may include a thermal insulation layer to reduce heat flow in and out of the drawers, for example, by comprising two or more layers of solid transparent material, such as glass or plastic polymer, with one or more thermal insulation layers of air, gas, or vacuum therebetween.

The refrigeration unit, in accordance with embodiments, may be integral with an ‘island’ kitchen structure, or may include one or more island structure connection elements, such as: bumps, dents, ridges, channels, edges, grooves, shafts, screws and/or other elements for connecting to complementary structures/elements of the island structure and retaining the refrigeration unit to its top at a specific orientation/position.

According to some embodiments, the refrigeration unit may include evaporator coils that may be positioned around the drawers at a vertical orientation. The refrigeration unit may further include evaporator coils that may be positioned at the middle/center area of the unit. A compressor of the refrigeration unit, positioned under one of the refrigeration unit's corners, may serve as a “foot” of the island structure, whereas the rest of the island structure's space may include cabinets and/or drawers of various types.

The top surface/sheet/layer of the refrigeration unit may for example be a ‘smart glass’ type surface, enabling the shifting/changing of the top surface from being transparent to being opaque and vice versa, thus facilitating a ‘drawers’ content visible' mode/setting and a ‘drawers’ content invisible' mode/setting. According to some embodiments, multiple ‘smart glass’ type surfaces may each cover one of the drawers, to collectively form the top surface/sheet/layer of the refrigeration unit, wherein each of the surfaces may be selectively/independently switched by the user between transparent and opaque modes.

The refrigeration drawers may be sealed with suitable insulation to prevent heat from getting into the unit and/or its drawers, for example, using refrigerator door seal or gasket. Each drawer/storage-unit may be independently sealed, such that when opened it is solely exposed to ambient temperatures, while keeping the other units in the desired refrigeration temperature. The drawers' body may be of a fully or partially transparent material such as glass, plastic and/or any other material or material combinations/compounds having light transparent characteristics.

The transparent drawers' body may enable one or more monitoring cameras to acquire images through the drawers' body and generate image data analyzed to detect the color and/or shape of drawers stored items. Items' color and shape, and its change patterns along time, may be analyzed to generate indications of drawers stored items'—in particular, fruits and vegetables—freshness level and expiration time, these may be notified to the refrigeration unit's user over a unit display/output component and/or communicated to an associated user device application. The color and image analysis may for example alert of each detected rotten fruit or vegetable and predict time for throw away by using identification/reference by color/shape and color/shape changes.

Monitoring cameras image data may be further stored and analyzed to track and manage the refrigeration unit's drawers' items inventory/list. For example, an items (e.g. fruits) count and a roster forecast may be generated and presented to the user, inventory matching shopping options may further be generated and suggested to the user.

A refrigeration unit system in accordance with embodiments, may include a computerized/mobile device application, for notifying the user of the refrigeration unit's stored items condition and for providing related data, as described here. The computerized/mobile device application may further receive and relay user inputs/indications/records regarding the types and amounts/numbers/quantity of items—such as various fruits & vegetables—she/he would like to have in the refrigeration unit when full, along with their respective minimal amounts/numbers/quantity. The system may keep track of the quantities in stock. The monitoring cameras' data may be analyzed, optionally in real-time, to provide an alert—for example, by a notification to the user's computerized/mobile device application and/or to the refrigeration unit's control/user interface—if the count is lower than the user's minimal record and there is a need of purchasing and renewing the stock, market purchase options may be further provided.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings:

FIG. 1A is a diagram of an exemplary refrigeration or storage unit, in accordance with some embodiments;

FIG. 1B is a diagram of an exemplary refrigeration unit including refrigeration components, in accordance with some embodiments;

FIG. 1C is a diagram of an exemplary refrigeration unit having a single transparent, substantially flat, top surface/sheet/layer including a thermal insulation layer, in accordance with some embodiments;

FIG. 1D is a diagram of an exemplary refrigeration unit having multiple drawer(s) specific, transparent, substantially flat, top surfaces/sheets/layers, each including a thermal insulation layer, in accordance with some embodiments;

FIG. 2A is a diagram of an exemplary refrigeration unit drawer, wherein the back edges area of the drawers' fronts is lined with a seal, in accordance with some embodiments;

FIG. 2B is a diagram of an exemplary refrigeration unit drawer, wherein the top edges of the drawers' walls are lined with a seal, in accordance with some embodiments;

FIG. 3 is a diagram of an exemplary refrigeration unit, wherein a compressor of the refrigeration unit is positioned outside and under one of the corners/sides of the unit's drawers structure/frame, in accordance with some embodiments;

FIG. 4 is a diagram of an exemplary refrigeration unit integrated with an ‘island’ kitchen structure, in accordance with some embodiments;

FIG. 5A is a diagram of an exemplary refrigeration unit, wherein the top surface/sheet/layer of the refrigeration unit is a ‘smart glass’ type surface, shown in its opaque state, in accordance with some embodiments;

FIG. 5B is a diagram of an exemplary refrigeration unit, wherein the top surface/sheet/layer of the refrigeration unit is a ‘smart glass’ type surface, shown in its transparent state, in accordance with some embodiments;

FIG. 5C is a diagram of an exemplary refrigeration unit, wherein each drawer includes a Light Emitting Diode (LED), and the LEDs are shown in an OFF state in accordance with some embodiments;

FIG. 5D is a diagram of an exemplary refrigeration unit, wherein each drawer includes a Light Emitting Diode (LED), and the LED of left drawer is shown in an ON state, in accordance with some embodiments;

FIG. 6A is a diagram of an exemplary refrigeration unit drawer, including one or more cameras to monitor goods/products/items stored within it, in accordance with some embodiments;

FIG. 6B is a diagram of a drawer content Image, generated by monitoring cameras positioned outside the drawers to acquire images through the drawers' transparent body, in accordance with some embodiments;

FIG. 6C is a diagram of an exemplary refrigeration unit, wherein monitoring cameras image data is stored and analyzed to track and manage the refrigeration unit's drawers' items inventory/list, inventory data is sent to and presented over a computerized mobile user device, in accordance with some embodiments; and

FIG. 7 is a schematic block diagram of an exemplary refrigeration unit system, in accordance with embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals or element labeling may be repeated among the figures to indicate corresponding or analogous elements.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, may refer to the action and/or processes of a computer, computing system, computerized mobile device, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In addition, throughout the specification discussions utilizing terms such as “storing”, “hosting”, “caching”, “saving”, or the like, may refer to the action and/or processes of ‘writing’ and ‘keeping’ digital information on a computer or computing system, or similar electronic computing device, and may be interchangeably used. The term “plurality” may be used throughout the specification to describe two or more components, devices, elements, parameters and the like.

Functions, operations, components and/or features described herein with reference to one or more embodiments, may be combined with, or may be utilized in combination with, one or more other functions, operations, components and/or features described herein with reference to one or more other embodiments.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “includes”, “including”, “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present disclosure is to be considered as an exemplification of the invention, it is not intended to limit the invention to the specific embodiments illustrated by the figures or description below.

A refrigeration or storage unit, in accordance with embodiments of the present invention, may include a drawers housing structure/frame to accommodate one or more drawers positioned, within the housing structure, at a substantially similar height to each other and over the same plane. The drawers housing structure/frame may include a transparent, substantially flat, top surface/sheet/layer to collectively cover the top openings of the one or more drawers when positioned within the housing structure/frame, while enabling a top view through the transparent surface, of items stored in the drawers.

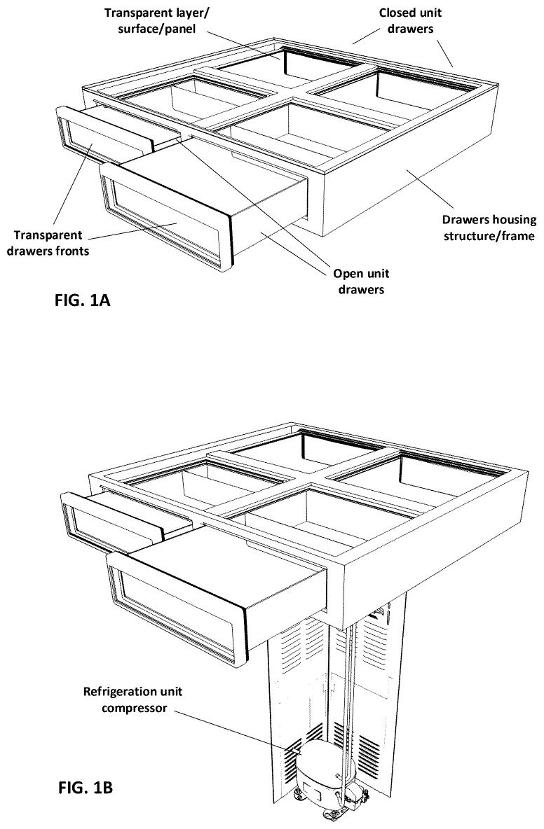

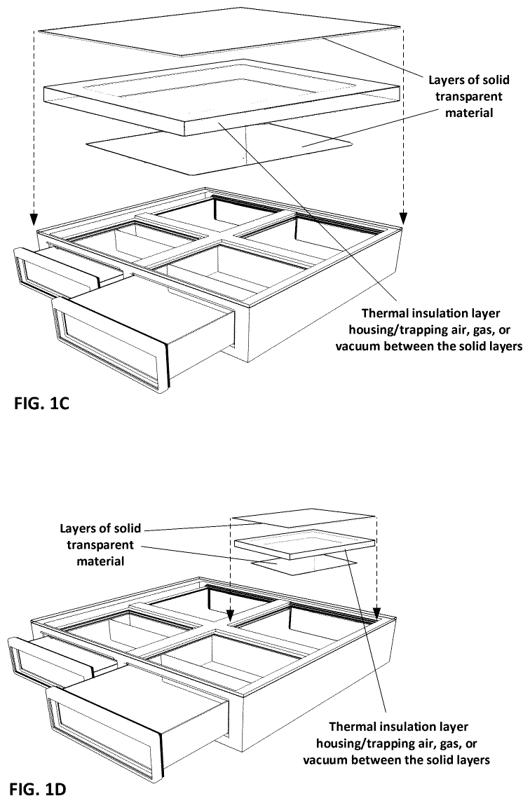

Reference is now made to FIG. 1A, where there is shown a diagram of an exemplary refrigeration or storage unit, in accordance with some embodiments. In the figure, a refrigeration/storage unit including 4 drawers, positioned within a drawers housing structure/frame, is covered by a single transparent layer/surface/panel is shown. The fronts of the drawers may also be transparent as exemplified in the figure.

A refrigeration unit, in accordance with embodiments of the present invention, may further include one or more refrigeration components, systems or devices to refrigerate/cool/chill the drawers' interior and items, such as food items, stored therein. According to some embodiments, the refrigeration component(s) may be an evaporative refrigeration and/or a thermo-electric refrigeration component. According to further embodiments, the refrigeration component(s) may be a dry ice refrigeration, a steam jet refrigeration, a liquid gas refrigeration and/or a vortex tube refrigeration component(s) or system.

Reference is now made to FIG. 1B, where there is shown a diagram of an exemplary refrigeration unit, in accordance with some embodiments. In the figure, a refrigeration unit including 4 drawers covered by a single transparent surface/panel is shown to include a refrigeration unit's compressor, as part of an evaporative refrigeration component/system of the unit, is positioned at the under one of the refrigeration unit's corners, resembling a unit's ‘leg’ structure.

A refrigeration or storage unit, in accordance with embodiments of the present invention, may include a transparent, substantially flat, top surface/sheet/layer to collectively cover the top openings of the two or more drawers when positioned within the housing structure/frame, while enabling a top view through the transparent surface, of items stored in the drawers. The transparent, substantially flat, top surface/sheet/layer may include a thermal insulation layer to reduce heat flow in and out of the drawers, for example, by comprising two or more layers of solid transparent material, such as glass or plastic polymer, with one or more thermal insulation layers of air, gas, or vacuum therebetween.

Reference is now made to FIG. 1C, where there is shown a diagram of an exemplary refrigeration unit having a single transparent, substantially flat, top surface/sheet/layer including a thermal insulation layer, in accordance with some embodiments. The refrigeration unit is shown to include a multi-drawer top surface/sheet/layer having two layers of solid transparent material, such as glass or plastic polymer, with a thermal insulation layer of air, gas, or vacuum therebetween.

A refrigeration or storage unit, in accordance with embodiments of the present invention, may include multiple transparent, substantially flat, top surfaces/sheets/layers to individually cover the top openings of the two or more drawers when positioned within the housing structure/frame, while enabling a top view through the transparent surface, of items stored in the drawers. The transparent, substantially flat, top surfaces/sheets/layers may each include a thermal insulation layer to reduce heat flow in and out of its respective drawer, for example, by comprising two or more layers of solid transparent material, such as glass or plastic polymer, with one or more thermal insulation layers of air, gas, or vacuum therebetween.

Reference is now made to FIG. 1D, where there is shown a diagram of an exemplary refrigeration unit having multiple drawer(s) specific, transparent, substantially flat, top surfaces/sheets/layers, each including a thermal insulation layer, in accordance with some embodiments. The refrigeration unit is shown to include a single-drawer top surface/sheet/layer having two layers of solid transparent material, such as glass or plastic polymer, with a thermal insulation layer of air, gas, or vacuum therebetween.

The transparent, substantially flat, top surface/sheet/layer may, in accordance with embodiments, may take the general form of, or may include, a double glazing or a double-paned window, a triple glazing or a triple-paned window, a or quadruple glazing or a quadruple-paned window.

The refrigeration unit drawers, in accordance with embodiments, may be sealed with suitable insulation elements to prevent heat from getting into the unit and/or its drawers, for example, using refrigerator door seal or gasket. Each drawer/storage-unit may be independently sealed, such that when opened it is solely exposed to ambient temperatures, while keeping the other units in the desired refrigeration temperature. The drawers' body may be of a fully or partially transparent material such as glass, plastic and/or any other material or material combinations/compounds having light transparent characteristics.

According to some embodiments, one or more back edges area of the drawers' fronts, may be lined with a seal, such that when a drawer is positioned within the housing structure/frame and closed, the seal contacts a front facing edge area of a respective drawer-opening within the drawers housing structure/frame to independently seal that drawer. According to some embodiments, a seal or sealing strip, may be positioned on the back edges area of the drawers' fronts, on the front facing edge area of the drawer-openings, or on both.

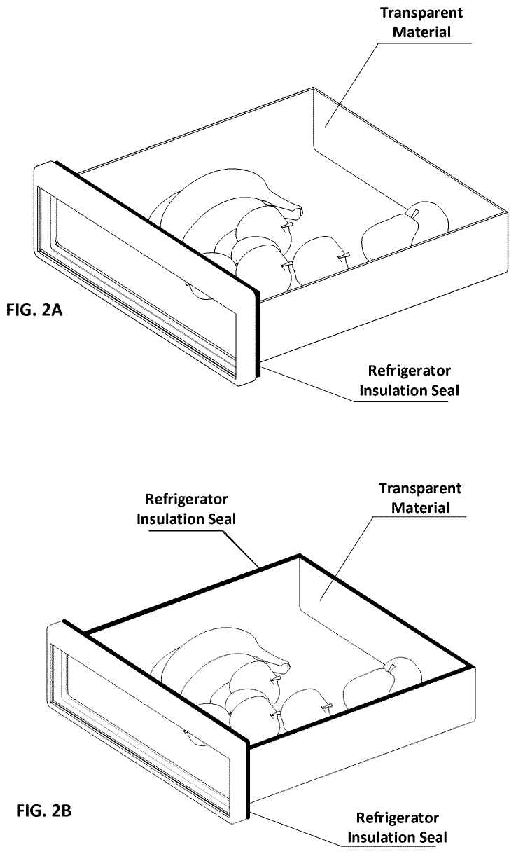

Reference is now made to FIG. 2A, where there is shown a diagram of an exemplary refrigeration unit drawer, wherein the back edges area of the drawers' fronts is lined with an insulation seal, in accordance with some embodiments.

According to some embodiments, one or more top edges of the drawers' walls may be lined with a seal, such that when a drawer is positioned within the housing structure/frame and closed, the seal contacts the bottom of the transparent top surface to independently seal that drawer.

Reference is now made to FIG. 2B, where there is shown a diagram of an exemplary refrigeration unit drawer, wherein the top edges of the drawers' walls are lined with an insulation seal, in accordance with some embodiments.

‘A Seal’, in accordance with embodiments, may comprise of any combination of thermal insulation material(s)/structure(s) that prevent air passage and thus mitigate temperature equilibrium tendency between the inside and outside of the drawer.

Evaporative refrigeration components, of a refrigeration unit in accordance with embodiments, may for example include a compressor, a condenser, an expansion valve, and an evaporator. According to some embodiments, evaporator coils of the evaporator may be positioned within, behind, under, on the sides, around and/or at the proximity of the drawers to deliver cold to them/their-interior. The evaporator coils may, for example, be positioned at a vertical orientation, optionally at the middle/center area of the refrigeration unit (e.g. adjacent to the back/side walls of the drawers when closed.

The compressor of the refrigeration unit may be positioned outside and/or under the refrigeration unit or one of the corners/sides. The compressor, or a supporting/housing structure thereof, may serve as a “foot” of an ‘island’ structure including the refrigeration unit, whereas the rest of the island structure's space may house the other refrigeration components (condenser, expansion valve, tubing, other), the unit's electric power board/control/circuitry, and/or may further include cabinets and/or drawers of various types.

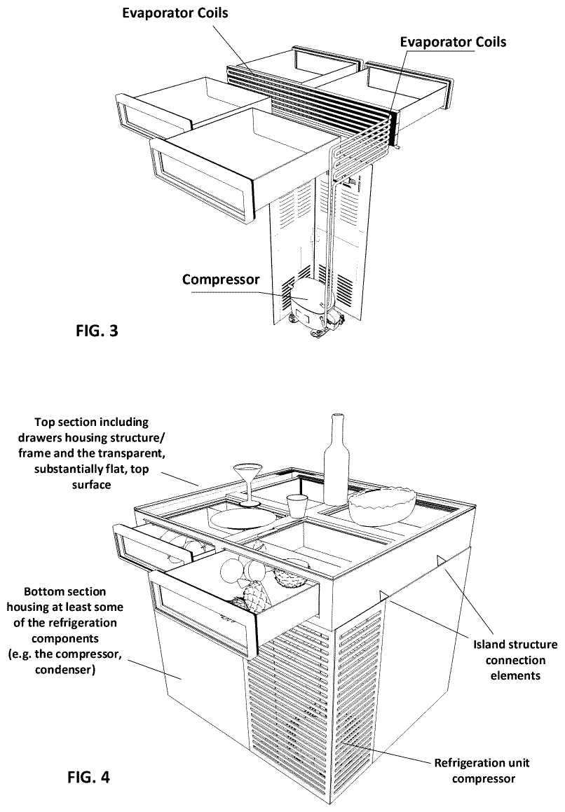

Reference is now made to FIG. 3, where there is shown a diagram of an exemplary refrigeration unit, wherein a compressor of the refrigeration unit is positioned outside and under one of the corners/sides of the unit's drawers structure/frame, in accordance with some embodiments. Evaporator coils of the unit's refrigeration system are shown to be positioned behind the drawers.

According to some embodiments, drawers cooling may be drawer-independent and/or may be applied/delivered through a mutually/centrally cooled space within drawers' housing/structure.

According to some embodiments, cooling/refrigeration levels may be selectively, and optionally unequally/unevenly, distributed between the unit's drawers. Accordingly, one or more drawers of the two or more drawers may be refrigerated to a first temperature while one or more other drawers of the two or more drawers are refrigerated to a second, different, temperature.

The different temperature in the drawers may, in accordance with some embodiments, be generated by different, fully or partially separated, refrigeration components, functionally associated with each drawer. For example, multiple Thermoelectric Cooler (TEC) components, or multiple evaporation refrigeration component sets, may each be functionally associated with a respective drawer.

The different temperature in the drawers may, in accordance with some embodiments, be generated by selectively/unevenly regulating/allocating/streaming the refrigeration of a single refrigeration component/device/system between each of the drawers. For example, specific drawer colling level or temperature may-automatically and/or based on a user command-be adjusted by temperature differentiation utilizing air streaming or pumping components and/or by a set of taps/faucets to control the compression of gas for each drawer, as indicated/defined by a respective metering device of that drawer.

The refrigeration unit, in accordance with embodiments, may be integral with an ‘island’ kitchen structure, or may include one or more island structure connection elements, such as: bumps, dents, ridges, channels, edges, grooves, shafts, screws and/or other elements for connecting to complementary structures/elements of the island structure and retaining the refrigeration unit to its top at a specific orientation/position.

An ‘island’ kitchen structure, in accordance with embodiments, may include: a bottom section housing at least some of the refrigeration components (e.g. the compressor, condenser) of the refrigeration unit and optionally additional storage spaces, drawers and/or shelves; and a top section, supported-by/positioned-on-top-of the bottom section, including drawers housing structure/frame and the transparent, substantially flat, top surface.

Reference is now made to FIG. 4, where there is shown, a diagram of an exemplary refrigeration unit integrated with an ‘island’ kitchen structure, in accordance with some embodiments. The top section refrigeration unit, bottom section ‘island’ structure, and island structure connection elements connecting therebetween are shown and indicated. Further shown is the refrigeration compressor, stored within the bottom section, optionally along with other/additional refrigeration components.

According to some embodiments, the top surface/sheet/layer of the refrigeration unit may be or include a ‘smart glass’ type surface, enabling the shifting/changing of the top surface from being transparent to being opaque and vice versa, thus facilitating a ‘drawers’ content visible' mode/setting and a ‘drawers’ content invisible' mode/setting.

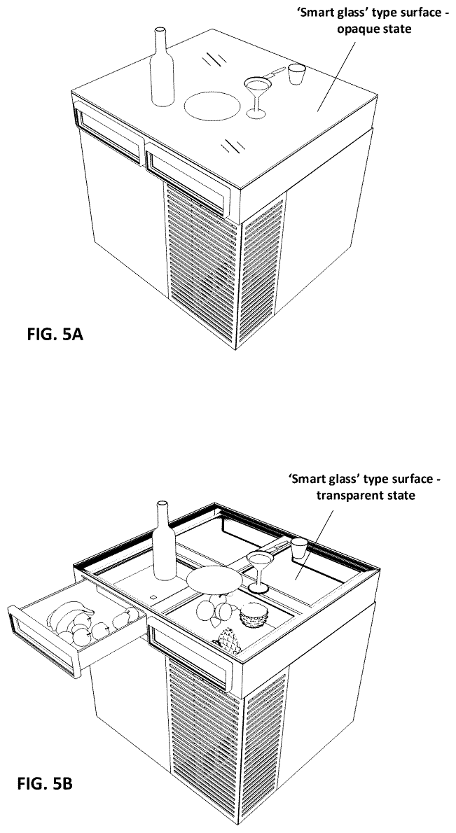

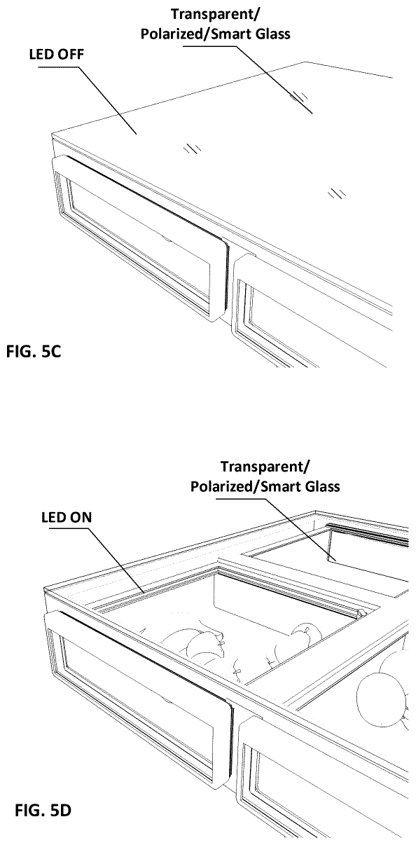

Reference is now made to FIG. 5A, where there is shown a diagram of an exemplary refrigeration unit, wherein the top surface/sheet/layer of the refrigeration unit is a ‘smart glass’ type surface, shown in its opaque state, in accordance with some embodiments.

Reference is now made to FIG. 5B, where there is shown a diagram of an exemplary refrigeration unit, wherein the top surface/sheet/layer of the refrigeration unit is a ‘smart glass’ type surface, shown in its transparent state, in accordance with some embodiments.

According to some embodiments, multiple ‘smart glass’ type surfaces may each cover one/some of the drawers, to collectively form the top surface/sheet/layer of the refrigeration unit, wherein each of the surfaces may be selectively/independently switched by the user between transparent and opaque modes.

According to some embodiments, each drawer may include a Light Emitting Diode (LED). The shifting/changing of a given one of the multiple ‘smart glass’ type surfaces from opaque to transparent may turn on one or more of the drawer LEDs which are associated with drawer(s) covered by the specific ‘smart glass’ surface that was shifted/changed.

According to some embodiments, the turning on of one or more of the drawer LEDs may trigger the shifting/changing of one or more of the multiple ‘smart glass’ type surfaces from opaque to transparent.

According to some embodiments, the turning on of one or more of the drawer LEDs may trigger the shifting/changing of a ‘smart glass’ type surface—of a refrigeration unit having a single top surface/sheet/layer covering all drawers—from opaque to transparent.

According to some embodiments, the top surface/sheet/layer of the refrigeration unit may be or include a polarized glass type surface. The top surface/sheet/layer may turn/become transparent/see-through upon turning on of one or more of the drawers' LEDs, as there is more/stronger light inside lit drawers than outside, facilitating transparency when viewing from the outside/top and into the lit drawer(s). Polarized top surface/sheet/layer areas over non-lit (i.e. LEDs off) drawers may remain opaque due to less/weaker light inside them than on their outside.

Reference is now made to FIG. 5C, where there is shown a diagram of an exemplary refrigeration unit, wherein each drawer includes a Light Emitting Diode (LED), and the LEDs are shown in an OFF state in accordance with some embodiments.

Reference is now made to FIG. 5D, where there is shown a diagram of an exemplary refrigeration unit, wherein each drawer includes a Light Emitting Diode (LED), and the LED of the left most drawer is shown in an ON state, in accordance with some embodiments.

A refrigeration unit, in accordance with embodiments, may include a user interface to control its refrigeration functions, ‘smart glass’ operation and/or drawers' LEDs. The user interface may take the form of a button or touch panel/interface that may for example be positioned on top of the refrigeration unit's top surface/sheet/layer; and/or, of a user application control interface, running on a computerized/mobile device communicating with a controller/processing-logic of the refrigeration unit through a unit communication module/circuitry.

According to some embodiments, a refrigeration unit's top surface/sheet/layer may include a touch interface wherein upon a user touching/swiping/pressing a specific point/area on top of the unit's top surface/sheet/layer, the operation of the LED and/or ‘smart glass’ of the drawer just-under/associated-with that point/area is triggered.

Any ‘smart glass’, polarized glass and/or other glass or ‘transparent surface/layer’ type may be combined or integrated with any insulation layer or layers, as described herein.

According to some embodiments, a refrigeration unit may include one or more cameras to monitor goods/products stored in its drawers. A processing logic may assess the freshness level or expiration date of the goods/products/items stored in the drawers based on camera acquired images. A processing logic, or processor, of a refrigeration unit in accordance with embodiments, may for example operate as standalone computing-unit with an option for cloud/IoT/Internet/online connection and communication with a mobile/computerized device application for the relaying and presentation of refrigeration unit operation data and/or stored items inventory data, and the sending of user control/operation commands and/or queries to the unit's processor.

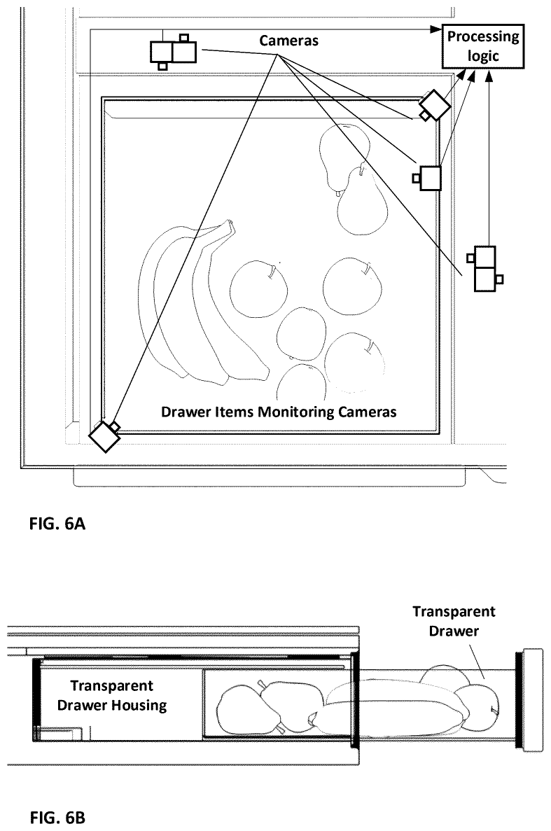

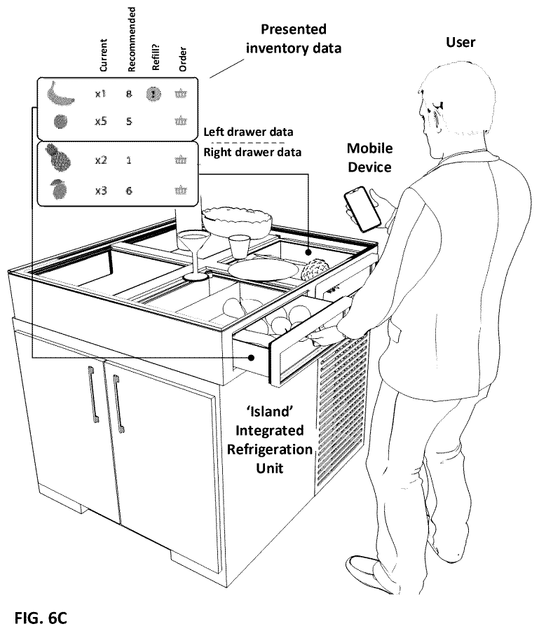

Reference is now made to FIG. 6A, where there is shown a diagram of an exemplary refrigeration unit drawer, including one or more cameras to monitor goods/products/items stored within it, in accordance with some embodiments. Cameras may be positioned, as shown, within, on the borders/edges of, and/or outside of the units' drawers. Data signals/streams representing cameras acquired images are relayed to the shown processing logic for drawer stored items analysis/assessment.

According to some embodiments, one or more monitoring cameras, or optical channels thereof, may be positioned within the drawers to monitor stored items. camera acquired images data may be communicated/relayed to the unit's processing logic over wire or wirelessly (e.g. over W-Fi, Bluetooth, other).

According to some embodiments, at least some of the drawers' body (e.g. side walls) may be transparent and may thus enable one or more monitoring cameras positioned outside the drawers to acquire images through the drawers' body and generate image data.

Reference is now made to FIG. 6B, where there is shown a diagram of a drawer content Image, generated by monitoring cameras positioned outside the drawers to acquire images through the drawers' transparent body, and optionally through the shown transparent drawers housing, in accordance with some embodiments.

According to some embodiments, drawers stored items may be monitored by one or more external cameras viewing the refrigeration unit from above and monitoring the items within the drawers through the unit's top transparent layer.

The image data may be analyzed to detect the color and/or shape of drawers stored items. Items' color and shape, and its change patterns along time, may be analyzed to generate indications of drawers stored items'—in particular, fruits and vegetables—freshness level and expiration time/date, these may be notified to the refrigeration unit's user over a unit display/output component and/or communicated to an associated user device application. The color and image analysis may for example alert of each detected rotten fruit or vegetable and predict time for throw away by using identification/reference by color/shape and color/shape changes.

Monitoring cameras image data may be further stored and analyzed to track and manage the refrigeration unit's drawers' items inventory/list. For example, an items (e.g. fruits) count and/or a roster forecast may be generated and presented to the user, inventory matching shopping options may further be generated and suggested to the user.

According to some embodiments, upon detection of an overly fresh (e.g. bad, rotten), expired, or missing/removed good/product/item an inventory list of the goods/products/items stored in the drawers is updated.

According to some embodiments, at a preset or user selected time, upon a threshold level/number of goods/products/items being indicated as bad/rotten/expired in the inventory list, and/or upon a user command, a shopping/procurement/roster list may be generated based on the inventory list. The shopping/procurement/roster list may then be relayed to a user(s) or to a goods/products/items retailer(s)/wholesaler(s)/supplier(s).

Reference is now made to FIG. 6C, where there is shown a diagram of an exemplary refrigeration unit, wherein monitoring cameras image data is stored and analyzed to track and manage the refrigeration unit's drawers' items inventory/list, inventory data is sent to and presented over a computerized mobile user device, in accordance with some embodiments.

The exemplary inventory data presented to the user, includes an indication of the stored item type (graphic icon in the example), its current amount in specific or in all drawers, the recommended amount for the item and whether a refill/purchase should made. The final column allows the user to select specific items she/he would like to trigger an order for, or to add them to their ‘shopping cart’ for the next triggered order.

The exemplary inventory data presented to the user, is shown to be divided to data relating to the left drawer's inventory (top rows) and data relating to the right drawer's inventory (bottom rows).

According to some embodiments, freshness level assessment may be at least partially based on identification/reference by goods/products/items color/shape/marks and/or by color/shape/marks trends/changes over time.

According to some embodiments, a Pixel Delta Comparison algorithm, an AI model utilizing Deep Learning techniques to classify items such as fruits & vegetables and their freshness level, and/or any other known in the art image classification algorithm, may be utilized to assess drawers stored items.

A refrigeration unit system in accordance with embodiments, may include a refrigeration unit and a computerized/mobile device application, for notifying the user of the refrigeration unit's stored items condition and for providing related data, as described here. The computerized/mobile device application may further receive and relay user inputs/indications/records regarding the types and amounts/numbers/quantity of items—such as various fruits & vegetables—she/he would like to have in the refrigeration unit when full, along with their respective minimal/threshold amounts/numbers/quantity. The system may keep track of the quantities in stock. The monitoring cameras' data may be analyzed, optionally in real-time, to provide an alert—for example, by a notification to the user's computerized/mobile device application and/or to the refrigeration unit's control/user interface—if the count is lower than the user's minimal record and there is a need of purchasing and renewing the stock, market purchase options may be further provided.

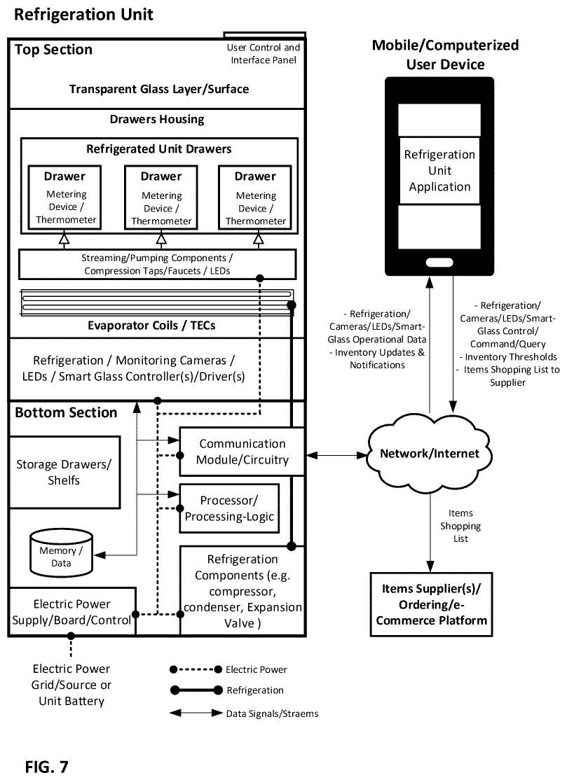

Reference is now made to FIG. 7, where there is shown a schematic block diagram of an exemplary refrigeration unit system, in accordance with embodiments. In the figure, a refrigeration unit including a top section and a bottom section is shown.

The top section includes a transparent top layer/surface and a drawers housing accommodating three drawers. The shown Streaming/Pumping-Components or Compression-Taps/Faucets control the distribution of cooling/heat-absorption, coming-from/originating-at the shown refrigeration Evaporator-Coils or TEC-units, between the different drawers. The distribution may be controlled and adjusted at least partially based on indications from the metering device and/or thermometer in each of the drawers. The top section further includes controllers/drivers for managing the operation of the unit's refrigeration components, stored items monitoring cameras, drawer LEDs, top layer smart glass and/or others. Further shown is a user control and interface panel to output/present (e.g. over display, sound, tactile UI) unit notifications and receive user inputs (e.g. through touch, press, speech UI).

The shown bottom section includes refrigeration components functionally connected with the evaporator coils or TECs of the top section to collectively generate the unit's refrigeration. An electric power supply/board/control receives electric power from the grid or a power source and allocates/distributes it between the refrigeration components, the shown processing-logic, and the shown communication module/circuitry of the unit. Power is also allocated/distributed to the Streaming/Pumping-Components or Compression-Taps/Faucets, LEDs, and Controllers/Drivers of the unit's top section. The bottom section is shown to further include a storage drawers/shelfs/cabinet space.

The refrigeration unit is shown to communicate with supplier(s) or an ordering platform to relay shopping lists/orders, generated by the unit's items inventory management functionalities as described herein, of unit stored items that need to be refilled.

The shown system further includes a mobile/computerized user device running a refrigeration unit client application. The application, through the mobile/computerized device, receives from the refrigeration unit: operational data associated with the unit's refrigeration, cameras, LEDs, smart-glass and/or other components; and inventory updates & notifications. The application, through the mobile/computerized device, sends to the refrigeration unit: control instructions, commands and queries to the refrigeration components, cameras, LEDs, smart-glass and/or other components; inventory thresholds, levels and values for unit stored items; and items shopping lists, or additions/corrections to unit's autogenerated list, for relaying to a supplier or an ordering/e-commerce platform.

A Refrigeration unit, in accordance with some embodiments of the present invention, may include: a drawers housing structure to accommodate two or more drawers positioned, within the housing structure, at a substantially similar height to each other and over the same plane; and/or a transparent, substantially flat, top surface to collectively cover the top openings of the two or more drawers when positioned within the housing structure or frame, while enabling a top view through the transparent surface, of items stored in the drawers.

According to some embodiments, the transparent top surface may include a thermal insulation layer. The thermal insulation layer may include trapped air or vacuum.

According to some embodiments, one or more top edges of the drawers' walls, or one or more back edges area of the drawers' fronts, may be lined with a seal, such that when a drawer is positioned within said housing structure/frame and closed, the seal independently seals that drawer.

According to some embodiments, one or more drawers of the two or more drawers may be refrigerated to a first temperature while one or more other drawers of the two or more drawers may be refrigerated to a second, different, temperature. The different temperature in the drawers may be generated by different, separate, refrigeration components, or by unevenly allocating the refrigeration of a single refrigeration component between each of the drawers.

According to some embodiments, a refrigeration unit may further comprise: one or more cameras to monitor items stored in the drawers; and a processing logic to assess the freshness level or expiration date of the goods/products/items stored in the drawers based on camera acquired images, the freshness level assessment may be at least partially based on identification of stored items' color, shape, or marks changes over time. Upon detection of an overly fresh, expired, or missing item, an inventory list of the items stored in the drawers may be updated. Upon a threshold number of items being indicated as overly fresh, expired, or missing in the inventory list, a shopping list may be generated based on the inventory list. The shopping list may be relayed to a user device or to an items supplier. The drawers' body may be fully or partially transparent and the monitoring camera(s) may acquire stored items images through the drawers' transparent body.

According to some embodiments, the unit may be integral with an ‘island’ kitchen structure, having: a bottom section housing a compressor of the refrigeration unit; and a top section including the drawers housing structure and the transparent, substantially flat, top surface.

According to some embodiments, the top section may include evaporator coils of the refrigeration unit. At least some of the condenser coils may be positioned between the drawers at a substantially vertical orientation.

According to some embodiments, the top surface of the refrigeration unit may include one or more ‘smart glass’ type surfaces, enabling the shifting/changing of the top surface from being transparent to being opaque and vice versa. Each drawer may include a Light Emitting Diode (LED) and the turning on of one or more of said LEDs may shift at least part of the one or more ‘smart glass’ type surfaces from opaque to transparent state.

A refrigeration system, in accordance with some embodiments of the present invention, may comprise a refrigeration unit, including: a drawers housing structure to accommodate two or more drawers positioned, within the housing structure, at a substantially similar height to each other and over the same plane; a transparent, substantially flat, top surface to collectively cover the top openings of the two or more drawers when positioned within the housing structure, while enabling a top view through the transparent surface, of items stored in the drawers; one or more cameras to monitor items stored in the drawers; a processing logic to assess the freshness level or expiration date of the items stored in the drawers based on camera acquired images and generate inventory data relating to the refrigeration unit's drawers stored items; a communication module to relay the inventory data to a user's computerized device application; and, the user computerized device application, for presenting the user with the inventory data over output components (e.g. display, speaker, tactile) of the device.

According to some embodiments, the user computerized mobile device application, may: receive user indications regarding the types and aspired numbers of items to have in the refrigeration unit when full, along with their respective minimal numbers; receive image data from one or more cameras monitoring the items stored in said refrigeration unit drawers; assesses the numbers of the items currently stored in said drawers based on camera acquired images; and calculate and notify of the differences between the current numbers and the aspired numbers, upon one or more numbers reaching their respective minimal values.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A refrigeration unit, including:
a drawers housing structure to accommodate two or more drawers positioned, within said housing structure, at a substantially similar height to each other and over the same plane; and
a transparent, substantially flat, top surface to collectively cover top openings of said drawers when positioned within said housing structure or frame, while enabling a top view through said transparent surface, of items stored in said drawers.

2. The refrigeration unit according to claim 1, wherein said transparent top surface includes a thermal insulation layer.

3. The refrigeration unit according to claim 2, wherein said thermal insulation layer includes trapped air or vacuum.

4. The refrigeration unit according to claim 1, wherein one or more top edges of said drawers' walls, or one or more back edges area of said drawers' fronts, are lined with a seal, such that when a given one of said drawers is positioned within said housing structure and closed, said seal independently seals that drawer.

5. The refrigeration unit according to claim 1, wherein one or more drawers of said two or more drawers is refrigerated to a first temperature while one or more other drawers of said two or more drawers is refrigerated to a second, different, temperature.

6. The refrigeration unit according to claim 5, wherein the different temperature in said drawers is generated by different, separate, refrigeration components.

7. The refrigeration unit according to claim 5, wherein the different temperature in said drawers is generated by unevenly allocating the refrigeration of a single refrigeration component between each of said drawers.

8. The refrigeration unit according to claim 1, further comprising:
one or more cameras to monitor items stored in said drawers; and
a processing logic to assess the freshness level or expiration date of the goods/products/items stored in said drawers based on camera acquired images.

9. The refrigeration unit according to claim 8, wherein upon detection of an overly fresh, expired, or missing item an inventory list of the items stored in said drawers is updated.

10. The refrigeration unit according to claim 9, wherein upon a threshold number of items being indicated as overly fresh, expired, or missing in the inventory list, a shopping list is generated based on the inventory list.

11. The refrigeration unit according to claim 10, wherein the shopping list is relayed to a user or to a supplier.

12. The refrigeration unit according to claim 8, wherein said drawers' body is fully or partially transparent and said monitoring camera(s) acquire stored items images through said drawers' transparent body.

13. The refrigeration unit according to claim 8, wherein the freshness level assessment is at least partially based on identification of changes in color, shape, or marks, of the stored items, over time.

14. The refrigeration unit according to claim 1, wherein said refrigeration unit is integral with an ‘island’ kitchen structure, having:
a bottom section housing a compressor of said refrigeration unit; and
a top section including said drawers, said drawers housing structure, and said transparent, substantially flat, top surface.

15. The refrigeration unit according to claim 14, wherein said top section further includes evaporator coils of said refrigeration unit.

16. The refrigeration unit according to claim 15, wherein at least some of said evaporator coils are positioned between said drawers at a substantially vertical orientation.

17. The refrigeration unit according to claim 1, wherein said top surface of said refrigeration unit includes one or more ‘smart glass’ type surfaces, enabling the shifting/changing of said top surface from being transparent to being opaque and vice versa.

18. The refrigeration unit according to claim 17, wherein each of said drawers includes a Light Emitting Diode (LED) and the turning on of one or more of said LEDs, shifts at least part of said one or more ‘smart glass’ type surfaces from opaque to transparent state.

19. A refrigeration system comprising:
a refrigeration unit, including:
a drawers housing structure to accommodate two or more drawers positioned, within the housing structure, at a substantially similar height to each other and over the same plane; and
a transparent, substantially flat, top surface to collectively cover the top openings of said two or more drawers when positioned within said housing structure, while enabling a top view through said transparent surface, of items stored in said drawers;
one or more cameras to monitor items stored in said drawers;
a processing logic to assess the freshness level or expiration date of the items stored in said drawers based on camera acquired images and generate inventory data relating to said refrigeration unit's drawers stored items;
a communication module to relay the inventory data to a computerized device application; and
said computerized device application, for presenting a user with the inventory data.

20. The refrigeration system according to claim 20, wherein said computerized/mobile device application:
receives user indications regarding the types and aspired numbers of items to have in said refrigeration unit when full, along with their respective minimal numbers;
receives image data from said one or more cameras monitoring the items stored in said refrigeration unit drawers;
assesses the numbers of the items currently stored in said drawers based on camera acquired images; and
calculates and notifies of the differences between the current numbers and the aspired numbers, upon one or more numbers reaching their respective minimal values.
